(19) United States
(12) Patent Application Publication
(10) Pub. No.: US 2007/0263506 A1
(43) Pub. Date: Nov. 15, 2007

(54) Method and system for detecting of errors on optical storage media

(75) Inventors: Jonathan Gulas, Ottawa (CA); Tim Beckwith, Ottawa (CA); Michael Kelland, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Clarestow Corporation, Ottawa (CA)

(21) Appl. No.: 11/431,998

(22) Filed: May 10, 2006

(51) Int. Cl. G11B 7/12; G11B 20/10

(52) U.S. Cl. 369/47.53

(57) ABSTRACT

A method of grading a level of damage to digital data provides a scan of the digital data for errors therein. Based on the detected errors and predetermined data based on at least one of audio human perception and human visual perception a grade of plain quality is determined. The grade of plain quality is then provided of an output from the system for interpretation by a user or a subsequent system.

### FIELD OF THE INVENTION

The invention relates to detection of errors within storage media and more particularly to the detection of errors within digital optical media.

### BACKGROUND

With the advent of the gramophone came commercially available recorded music. Commercially available recorded music generated an industry of distribution and sales and soon afterwards an industry of used music sales. Unfortunately, with used music sales came the problem of verifying a quality of the used music media. As music media was more and more used, it would be worn down and a quality of the music reproduction would decrease. Similarly with magnetic tape media, stretching of the media and magnetic effects thereto reduce the overall quality of sound reproduction over time. With the advent of video recorders (VCR) came an entire industry aimed at renting entertainment.

All of this changed with the invention of the compact disk (CD), the first commercially viable optically stored digital audio data. The CD provides about an hour of recorded music stored in digital form. Because the medium is optical, the audio data stored therein is not degraded through playback and, as such, the market for used CDs provides subsequent acquirers with an ability to purchase music with its original quality.

Because of this lack of degradation and reproduction quality achievable with digital media, digital video media followed the CD with the digital video disk (DVD) and is now the ubiquitous distribution method for movies and television shows that are sold. DVDs are also widely rented. Further computer software and video games are now distributed on CDs and DVDs as a matter of course.

The rental industry aims to ensure that each rental event is a satisfying event. In order to achieve this, DVDs are preferably kept in perfect condition. Unfortunately, for the used DVD market and for the DVD rental market it is impossible to force consumers to keep the media in pristine condition. Surface scratches, dirt, and more substantial damage occur within DVDs and CDs during use by consumers. Though the damage is predictable statistically, the resulting unsatisfactory customer event when the CD or DVD is rented after being damaged is problematic. Generally this is handled by providing store credits or refunds, neither of which greatly increases customer satisfaction, and ultimately results in reduced business for the rental operation.

It would be advantageous to provide a method of evaluating optical storage media upon return to a rental depot to determine if they should be re-rented.

To this end, it has been proposed to read an optical storage medium and to count a number of detected errors. The errors are then reported. Unfortunately, for a typical rental depot employee, the error report does not help them to evaluate a re-rentability of the medium. Also, the error count may have no correlation to the effect of the errors on the experience of the entertainment and, as such, may or may not be a significant measure.

It would be advantageous to provide a method and system for providing a more accurate indication of the effects of damage on entertainment based on data within an optical medium.

It would also be advantageous to provide a method and system for providing a method of repairing optical storage media based on an indication of the effects of damage on entertainment based on data within an optical medium.

### SUMMARY OF THE INVENTION

In accordance with an embodiment of the invention there is provided a method for inspecting an optical disk having data stored therein comprising: scanning the optical disk for detecting defects; determining a defect index in dependence upon the detected defects; providing a look-up table comprising a plurality of table indices, wherein each table index of the plurality of table indices is indicative of a grade of playing quality of data stored in an optical disk in presence of a respective pattern of defects of a plurality of different patterns of defects, the grade of playing quality being determined based on at least one of human audio and human visual perception; comparing the defect index with the table indices; and, providing first inspection data if the defect index is within a predetermined range of a table index indicative of a grade of sufficient playing quality.

In accordance with an embodiment of the invention there is provided a method for inspecting an optical disk having data stored therein comprising: scanning the optical disk for detecting defects; determining scan data in dependence upon the detected defects; providing playing quality data indicative of a plurality of grades of playing quality of data stored in an optical disk, wherein each grade is determined based on at least one of human audio and human visual perception of the data stored in the optical disk in presence of a respective pattern of defects of a plurality of different patterns of defects; comparing the scan data with the playing quality data and providing a comparison result in dependence thereupon; and, providing first inspection data if the comparison result is indicative of a grade of sufficient playing quality.

In accordance with an embodiment of the invention, provided apparatus for performing the above method.

### BRIEF DESCRIPTION OF THE DRAWINGS

The invention will now be described with reference to the attached drawings in which:

FIG. 1a, shown is a bottom view of an optical medium in the form of a CD;

FIG. 1b is shown a side view of the optical medium;

FIG. 2a, shown is a bottom view of an optical medium in the form of a DVD;

FIG. 2b is shown a side view of the DVD;

FIG. 3 is a simplified flow diagram of a method of reading information from an optical storage medium;

FIG. 4 is a simplified flow diagram of a method of forming a lookup table relating human experience to detected errors;

FIG. 5 is a simplified flow diagram of a method of testing an optical storage medium for errors based on human experience and qualitative data;

FIG. 6 is a simplified flow diagram of a method of forming a lookup table relating human experience in each of audio playback and video playback to detected errors;

FIG. 7 is a simplified flow diagram of a method of forming a lookup table relating human experience to detected errors wherein the human experience is evaluated for different audio/video titles;

FIG. 8 is a simplified flow diagram of a method of forming a lookup table relating optical storage medium genre and detected errors to human experience;

FIG. 9 is a simplified flow diagram of a method of forming a lookup table relating optical storage medium identifier and detected errors to human experience;

FIG. 10 is a simplified flow diagram of a method of guaranteeing used optical storage media;

FIG. 11 is a simplified flow diagram of a method of certifying optical storage media;

FIG. 12 is a simplified flow diagram of a method of forming a lookup table for an optical storage medium having video game data stored thereon relating detected errors to human experience; and,

FIG. 13 is a simplified flow diagram of a method for improving error detection efficiency in optical storage media.

### DETAILED DESCRIPTION OF AN EMBODIMENT OF THE INVENTION

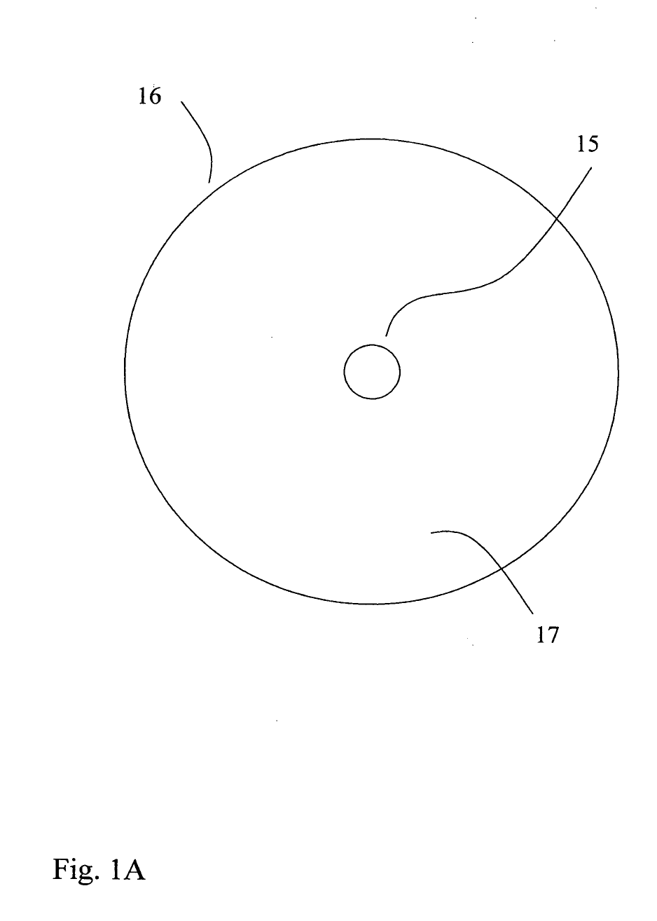

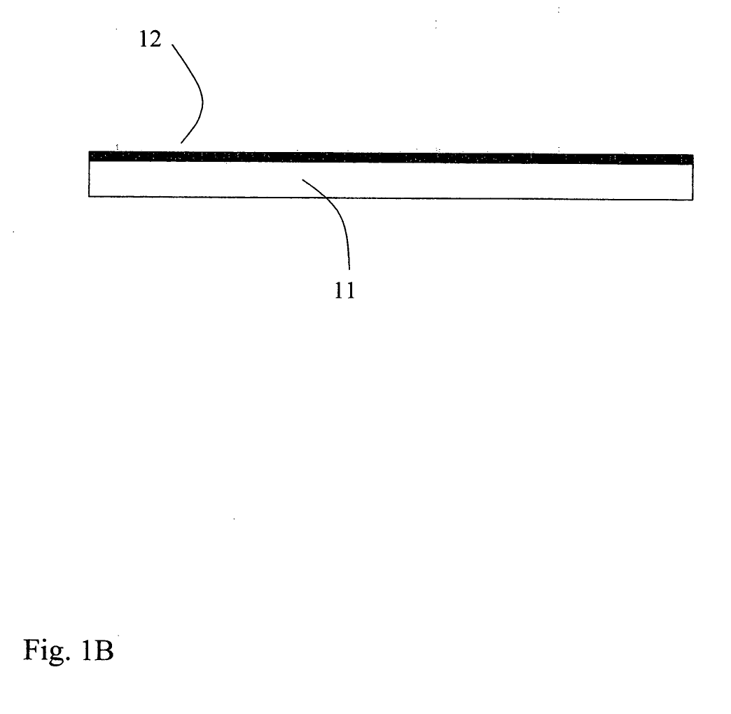

Referring to FIG. 1a, shown is a bottom view of an optical medium in the form of a CD. The optical medium has a hub 15, a rim 16, and an information storage area 17. Within the information storage area 17, bits (binary information) are stored optically. Optical data storage and methods therefore are well known. In FIG. 1b is shown a side view of the optical medium. The optical medium comprises a substrate 11 and an information storage surface 12. A label on an opposing side of the information storage surface 12 provides for light reflection from the information storage surface. Damage to the information storage surface typically results in lost data.

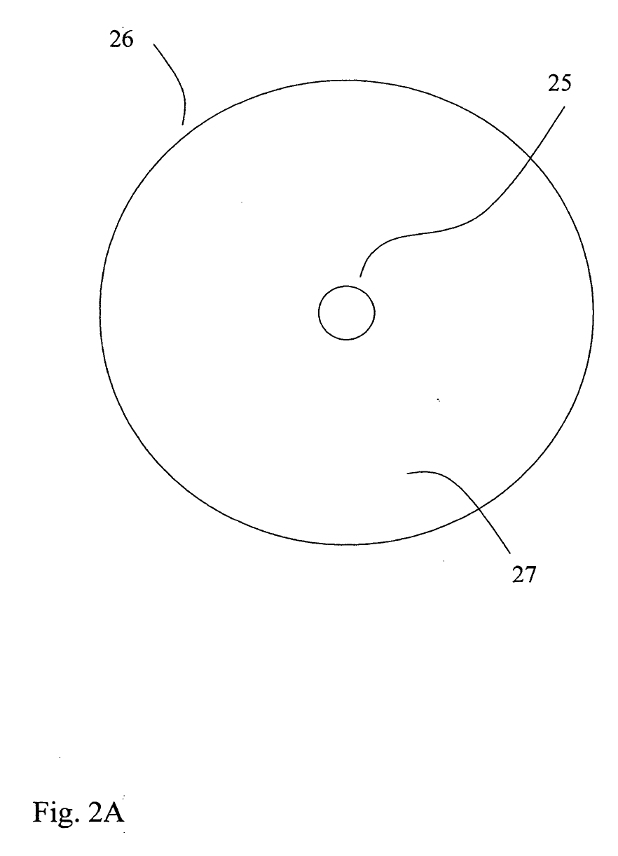

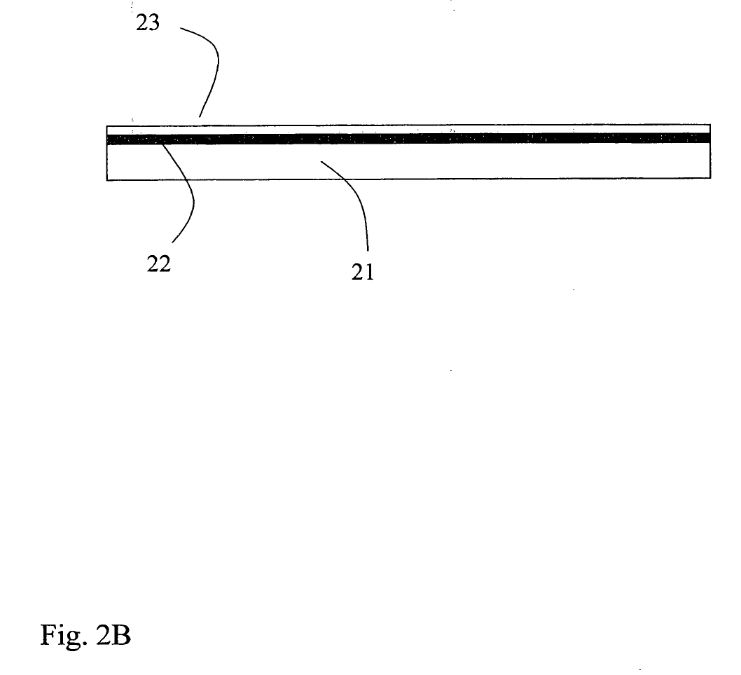

Referring to FIG. 2a, shown is a bottom view of an optical medium in the form of a DVD. The optical medium has a hub 25, a rim 26, and an information storage area 27. Within the information storage area 27 bits (binary information) are stored optically. Optical data storage and methods therefore are well known. In FIG. 2b is shown a side view of the DVD. The DVD comprises a substrate 21, an information storage surface 22, and a protective surface 23. Optionally, a label is applied or printed onto the protective surface 23.

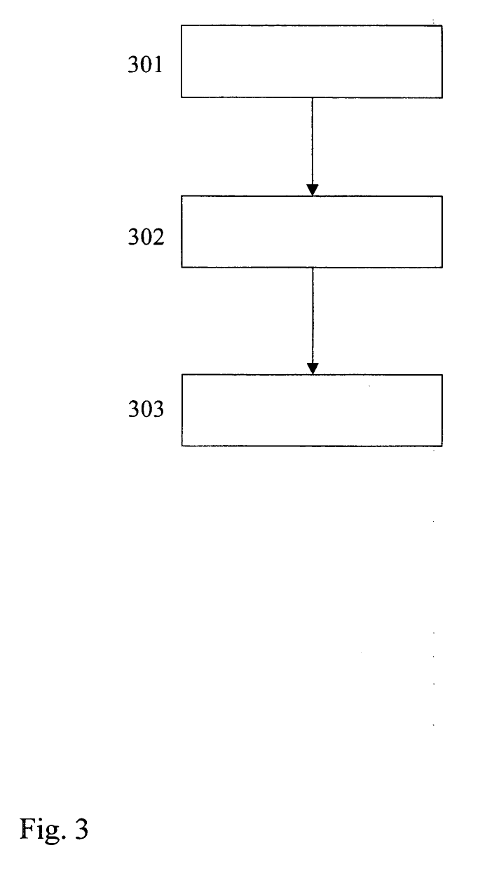

Referring to FIG. 3, shown is a simplified flow diagram of a method of reading information from an optical storage medium. At 301, a command is initiated by a host system for the optical media reading hardware to retrieve data from a known location within the optical storage medium. At 302, the optical media reading hardware locates the data and retrieves it from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose.

At 303, the host system receives an indication of the data and of errors detected within the data. The host system then proceeds to process the data for use, display, or play depending upon data content. Of course, when data integrity is essential, an indication of an error causes the system to indicate a data read error and cease operation upon the data. Of course, it is well known that for audio and video data, an error may not render the information unusable but sometimes results in errors in display or play of the audio-visual data.

In reading of data from the optical storage medium, the hardware transport reads data at a speed that is an integer multiple of a playback speed for the medium. For example, though a typical CD holds about an hour of music, many presently available optical storage medium readers read data from a complete CD in less than two minutes at speeds of 48 times the playback rate of the music. As such, for data reading the rate is faster and for audio playback the hardware either slows down the reading rate or samples a same bit several times—over sampling—during playback. Over sampling allows for a same bit to be verified through repeated reading.

Unfortunately it is known that for some errors, reading of a single bit at a slower rate is often more accurate than reading of the same bit at a higher rate. That said, it is also known that for reading of data by a computer, faster reading rates are preferred as they allow for faster response times. As such, a cost benefit arises to operating the optical media reading hardware at higher rates—more errors with faster operation and fewer errors with slower operation. This balance is carefully managed in optical storage media optical media reading hardware design.

Unfortunately, even though physical damage or bit errors within an optical medium result in some errors in playback of the content of the optical storage medium, it is difficult to estimate an effect of this on someone appreciating the content. That said, typically, the effects on someone perceiving the content is what distinguishes significant damage from insignificant damage. In the video rental industry, this effect is determined based on customer feedback upon returning a rented DVD. Unfortunately, the customer experience has already been affected by any damage perceived.

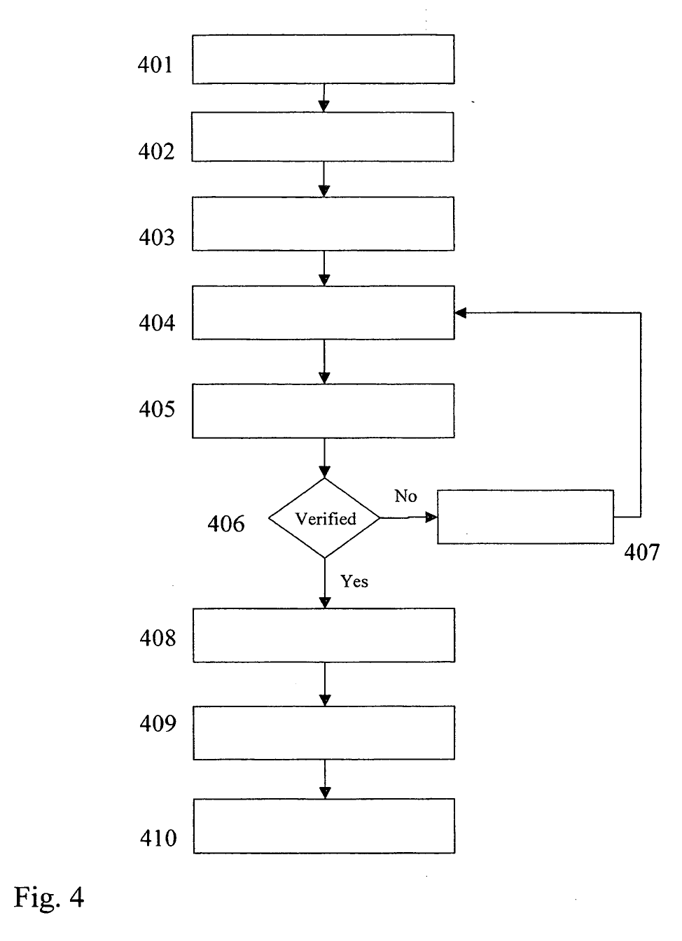

Referring to FIG. 4, shown is a simplified flow diagram of a method of evaluating a qualitative nature of errors within an optical storage medium. At 401, a damaged optical medium is used to play for each of one or more individuals a performance retrieved and played from the damaged optical medium. At 402, the experiences are evaluated and data relating to the experiences is stored. At 403, the optical storage medium is provided for error evaluation. At 404, optical media reading hardware locates the data and retrieves same from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 405, the host system records any detected errors. At 406 the host system determined whether the entire optical storage medium has been verified. When the storage medium is not yet verified, the host system, at 407, provides a command for retrieving data from a new known range of locations within the optical storage medium and then returns to 404. When the entire optical storage medium has been verified, the host system compiles all of the results of detected errors at 408. At 409, the results of the detected errors are stored in association with the qualitative data relating to the experiences and provided by the one or more individuals. This process is then repeated for a variety of different damage to the optical medium.

At 410, a table is formed of the different detected errors and a resulting qualitative data relating to the experiences. This table is then used in analysis of optical storage media in order to determine data relating to human experience.

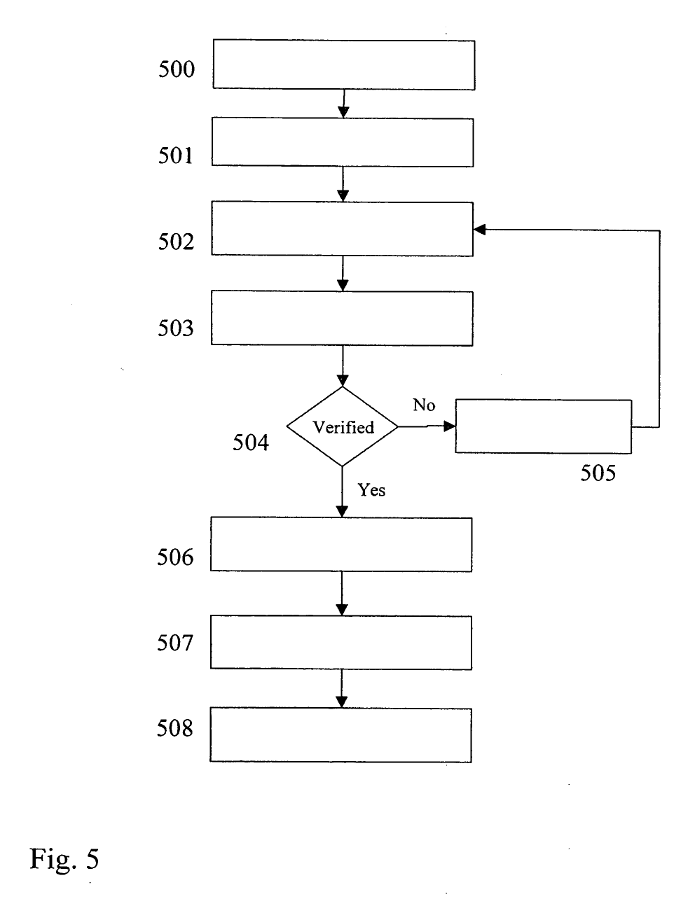

Referring to FIG. 5, shown is a simplified flow diagram of a method of evaluating an optical storage medium. At 500, an optical storage medium is transferred to an optical reader. At 501, a command is initiated by a host system for a optical media reading hardware to retrieve data from a known range of locations within the optical storage medium at a highest available data reading rate. At 502, the optical media reading hardware locates the data and retrieves it from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 503, the host system records any detected errors. At 504 the host system determined whether the entire optical storage medium has been verified. When the storage medium is not yet verified the host system, at 505, provides a command for retrieving data from a new known range of locations within the optical storage medium and then returns to 502. When the entire optical storage medium has been verified, the host system compiles all of the results of detected errors at 506. At 507, the detected errors are correlated with detected errors within a lookup table to determine form the lookup table a human experience relating to the detected errors. At 508, an indication of the human experience is provided.

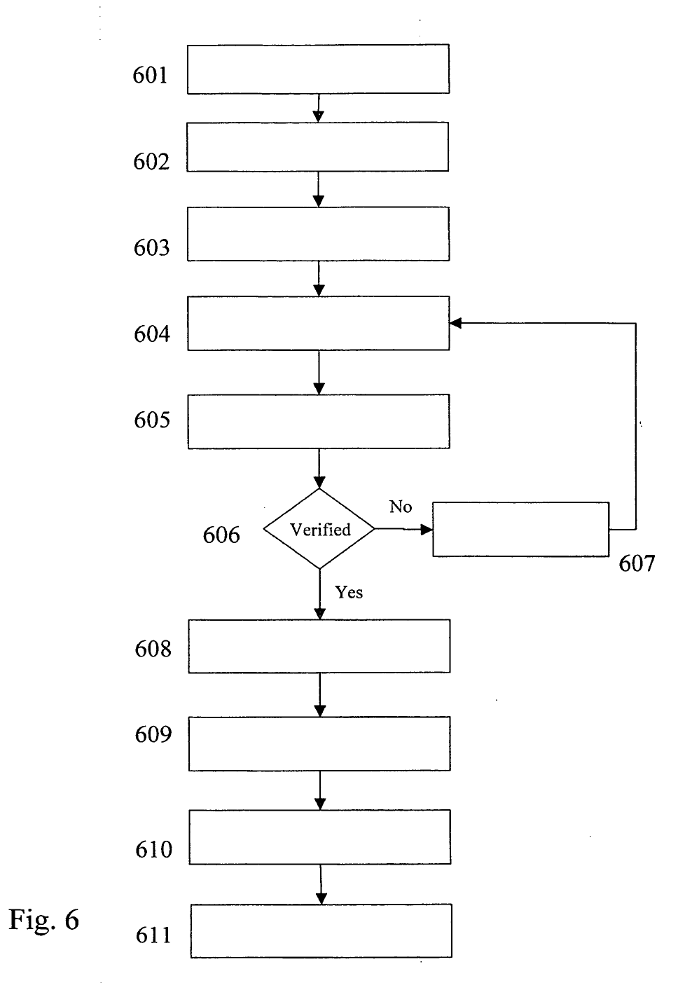

Referring to FIG.6, shown is a simplified flow diagram of a method of evaluating a qualitative nature of errors within an optical storage medium in the form of a DVD. At 601, a damaged DVD is used to play for each of one or more individuals a performance retrieved and played from the damaged optical medium. At 602, the experiences are evaluated and data relating to each of an audio experience and a video experience are stored. At 603, the optical storage medium is provided for error evaluation. At 604, optical media reading hardware locates the data and retrieves same from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 605, the host system records any detected errors. At 606 the host system determined whether the entire optical storage medium has been verified. When the storage medium is not yet verified the host system, at 607, provides a command for retrieving data from a new known range of locations within the optical storage medium and then returns to 604. When the entire optical storage medium has been verified, the host system compiles all of the results of detected errors at 608. At 609, the results of the detected errors are stored in association with the qualitative data relating to the audio and video experiences and provided by the one or more individuals. This process is then repeated for a variety of different damage to the DVD.

At 610, the different detected errors are correlated with the audio and video experience data to indicate error or groups of errors that are likely to affect audio quality and other errors that are likely to affect video quality. The process allows for detected errors to be more closely correlated to the human experience they affect. Alternatively, step 610 is not performed. At 611, a table is formed of the different detected errors and a resulting qualitative data relating to the experiences. This table is then used in analysis of optical storage media in order to determine data relating to human experience. A process similar to that of FIG. 5 is used to evaluate DVD media and based on the table so formed.

Alternatively, instead of forming a lookup table, a statistical mapping of human experience data to detected damage is determined based on the experience data and the detected errors. Further alternatively, a learning based system is taught with the experience data and the detected errors. When a learning system is taught, it is also possible to update the teachings at any later time.

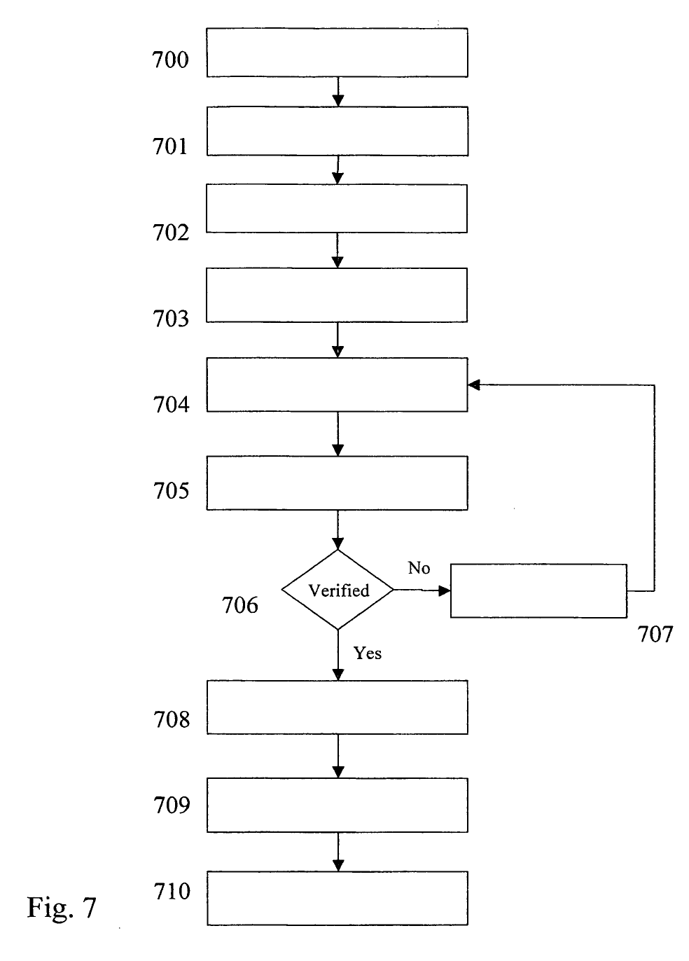

Referring to FIG. 7, shown is a simplified flow diagram of a method of evaluating a qualitative nature of errors within optical storage media. At 700, a plurality of different optical storage media are provided, each having a number of copies. Different copies of a same title are damaged differently. At 701, a damaged optical medium is used to play for each of one or more individuals a performance retrieved and played from the damaged optical medium. At 702, the experiences are evaluated and data relating to the experiences is stored. At 703, the optical storage medium is provided for error evaluation. At 704, optical media reading hardware locates the data and retrieves same from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 705, the host system records any detected errors. At 706 the host system determined whether the entire optical storage medium has been verified. When the storage medium is not yet verified the host system, at 707, provides a command for retrieving error data for data from a new known range of locations within the optical storage medium and then returns to 704. When the entire optical storage medium has been verified, the host system compiles all of the results of detected errors at 708. At 709, the results of the detected errors are stored in association with the qualitative data relating to the experiences and provided by the one or more individuals. This process is then repeated for the plurality of different optical media.

At 710, a table is formed of the different detected errors and a resulting qualitative data relating to the experiences. Discrepancies within the table—the same detected errors resulting in different user experiences are resolved according to predetermined criteria. For example, a most negative human experience is selected. Alternatively, a prevalent human experience is selected using a voting based system—the most similar results being selected. This table is then used in analysis of optical storage media in order to determine data relating to human experience.

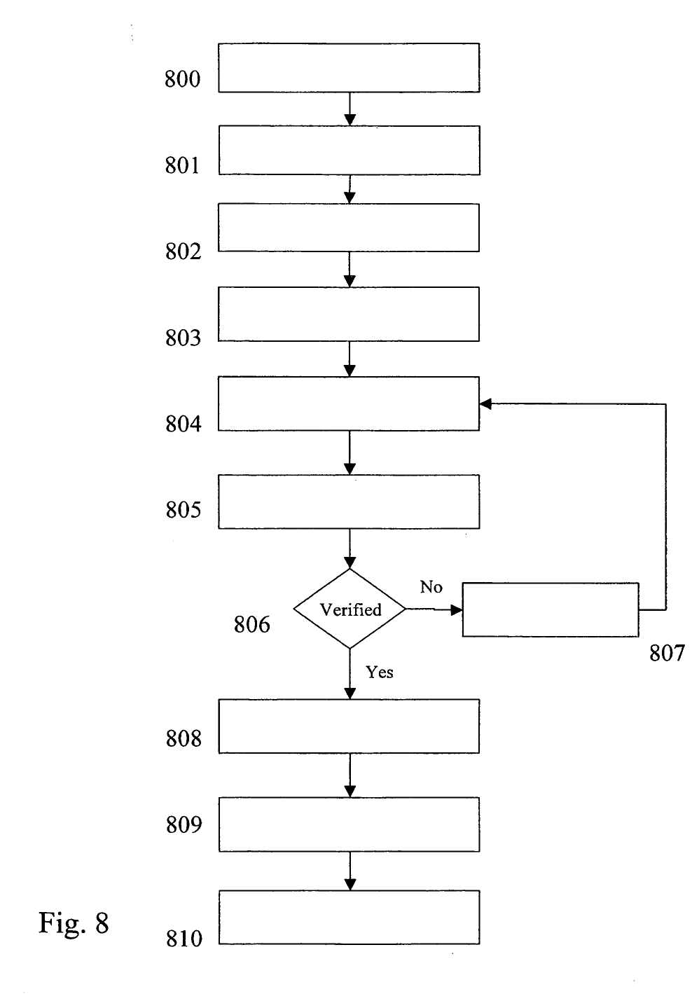

Referring to FIG. 8, shown is a simplified flow diagram of a method of evaluating a qualitative nature of errors within optical storage media. At 800, a plurality of different optical storage media are provided, each having a number of copies and a genre. Different copies of a same title are damaged differently. At 801, a damaged optical medium is used to play for each of one or more individuals a performance retrieved and played from the damaged optical medium. At 802, the experiences are evaluated and data relating to the experiences is stored. At 803, the optical storage medium is provided for error evaluation. At 804, optical media reading hardware locates the data and retrieves same from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 805, the host system records any detected errors. At 806 the host system determined whether the entire optical storage medium has been verified. When the storage medium is not yet verified the host system, at 807, provides a command for retrieving error data for data from a new known range of locations within the optical storage medium and then returns to 804. When the entire optical storage medium has been verified, the host system compiles all of the results of detected errors at 808. At 809, the results of the detected errors are stored in association with the qualitative data relating to the experiences and provided by the one or more individuals. This process is then repeated for the plurality of different optical media.

At 810, a table is formed of the different detected errors and a resulting qualitative data relating to the experiences. The genres are also used to form the table such that the table reflects a genre and damage type to human experience. For example, when the optical medium is a CD, a classical recording with similar damage to a modern popular music recording may result in a very different human experience. As such, dividing music into Genres is advantageous in generating the table. This table is then used in analysis of optical storage media in order to determine data relating to human experience.

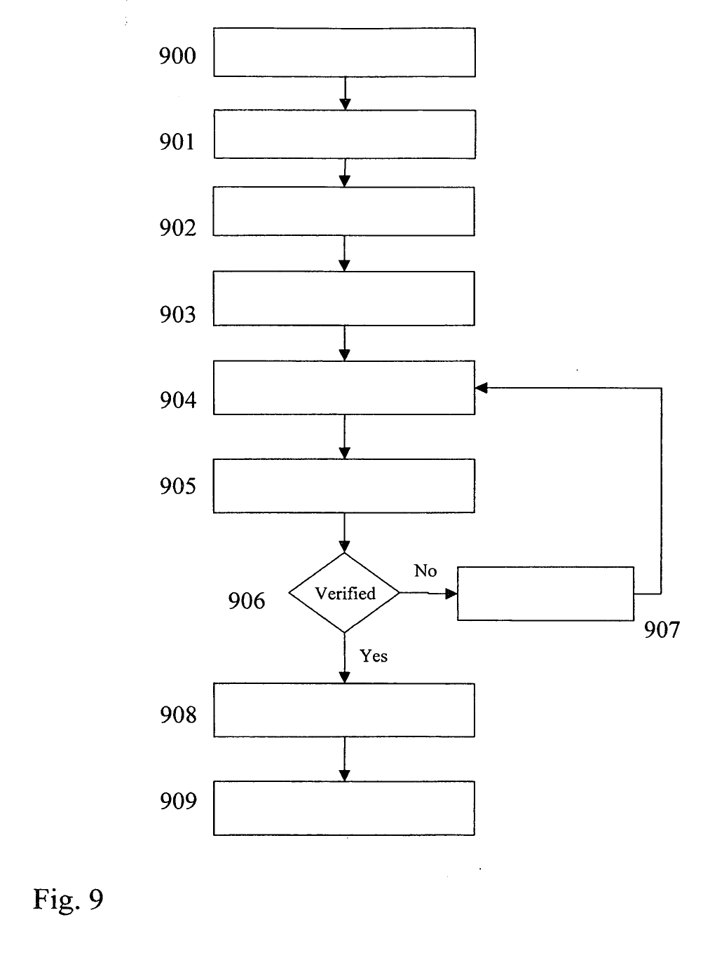

Alternatively, instead of genre, optical media are grouped based on actual experiential data and a resulting table entry. Referring to FIG. 9, shown is a simplified flow diagram of a method of evaluating a qualitative nature of errors within optical storage media. A plurality of individuals are each provided with an optical storage medium a content of which they are to experience. Upon completing the experience, each optical storage medium is provided to an optical storage medium reader at 900. At 901, a damaged optical medium is used to play for each of one or more individuals a performance retrieved and played from the damaged optical medium. At 902, the experiences are evaluated and data relating to the experiences is stored. At 903, the optical storage medium is provided for error evaluation. At 904, optical media reading hardware locates the data and retrieves same from the optical storage medium. As part of the data retrieval process, the optical media reading hardware provides to the host system the data and indication of errors identified, at the hardware level, within the data. These errors typically relate to errors detectable through a use of error detection codes such as checksums, hashes, etc. One of skill in the art of error detection and error correction coding will understand that many different codes are applicable for the recited purpose. Alternatively, only the indications of errors are retrieved, for example, error checking results. When this is the case, the bandwidth constraints and amount of data transferred is significantly reduced. By processing less data, a faster process results. Beneficially, by working from the error checking results, error correction features within the hardware or programming of a system are bypassed allowing for a more universal assessment of the medium. Thus, a medium is evaluated as it is and not based on a potential quality or lack thereof in the reading hardware.

At 905, the host system records any detected errors. At 906 the host system determined whether the entire optical storage medium has been verified. When the storage medium is not yet verified the host system, at 907, provides a command for retrieving error data for data from a new known range of locations within the optical storage medium and then returns to 904. When the entire optical storage medium has been verified, the host system compiles all of the results of detected errors at 908. At 909, the results of the detected errors are stored in association with the qualitative data relating to the experiences and an identifying code of the optical storage medium.

For example, by networking DVD rental businesses together, for each returned DVD there is a data point. When no customer feedback is received, the DVD is verified and assumed to have provided an adequate experience. When a complaint is provided, the experience is entered, selected from available experiences. Some exemplary user experiences include: sound was screwed up, sound was horrible, sound was inaudible, video was screwed up, video was horrible, DVD would not play, stops after 30 minutes, and so forth. Systems at different business locations share the data gathered and formulate one large table including each DVD identifier, human experiences collected relating to the DVD and determined damage of the CD for each human experience. Conflicts are resolved according to predetermined policy. For example, if there is a policy that every patron should always have an enjoyable experience, a most negative human experience is selected when a conflict occurs. Alternatively, an average human experience is selected. Further alternatively, a voting method is employed wherein a most common human experience is selected. Sharing of the data between business locations allows for a tremendous amount of data to be gathered in a very short period of time.

For example, a major chain of video rental stores each has similar stock in DVDs. Thus, even with more obscure DVDs, which may only be rented once a month, with 10,000 locations that provides 10,000 data points per month for the obscure DVD. For more popular DVDs, more than 10 times that number of data points is likely each day. Thus, the resulting table is not indexed by genre and detected errors but by individual title and detected errors providing for accurate correlation. Further, human error in data entry is statistically filterable as it represents outlying values that are discardable.

The resulting table is either shared amongst stores or is accessible via a communication medium such as the Internet to provide an indication of a human experience achievable via a particular medium.

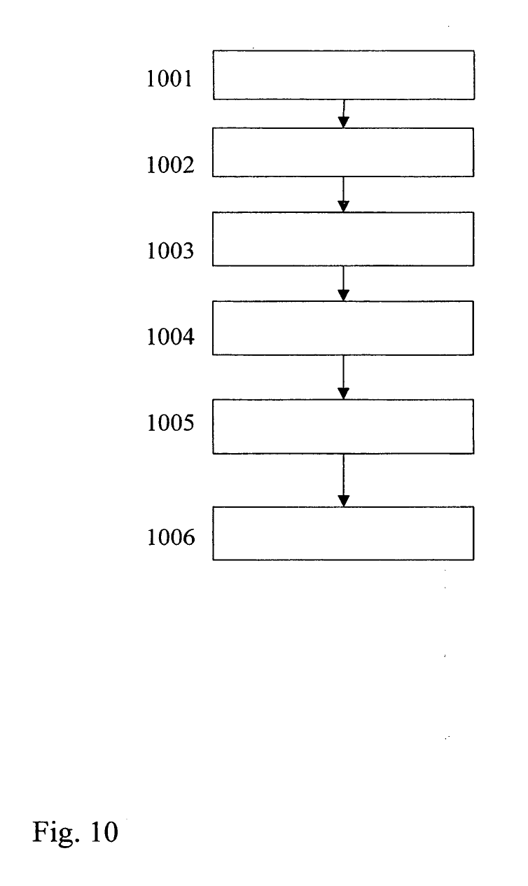

Referring to FIG. 10, shown is a simplified flow diagram of a method of guaranteeing used optical storage media. At 1001, a used optical storage medium is provided for verification. At 1002 the optical storage medium is inserted within an optical medium reader having suitable programming for verifying of optical storage media. The optical medium reader proceeds to read the data from the optical storage medium in order to determine an amount and characteristic of optical storage medium damage at 1003. At 1004, it is determined based on human experience data whether or not the storage medium is sufficiently reliable. When it is, the optical storage medium is indicated as verified at 1005. Alternatively, when it is determined that the storage medium is not verifiable, then a new optical storage medium is provided. At 1006, a fee is charged for the new optical storage medium. Thus, for example, the provider of the optical storage media generates revenue in replacing of damaged media, the revenue less than the revenue generated for new media. Further alternatively, no fee is charged. Optionally, the unverified optical storage medium is destroyed as part of the replacement process.

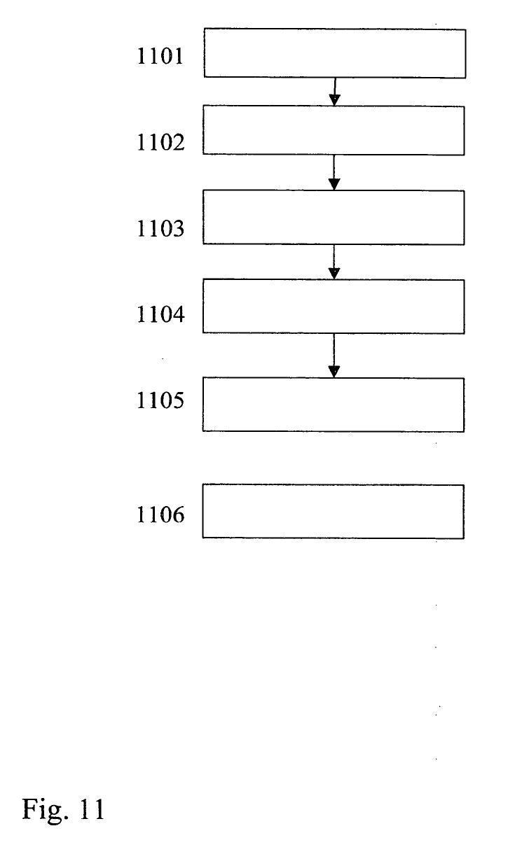

Referring to FIG. 11, shown is a simplified flow diagram of a method of certifying optical storage media. At 1101, a used optical storage medium is provided for certification. At 1102 the optical storage medium is inserted within an optical medium reader having suitable programming for certifying of optical storage media. The optical medium reader proceeds to read the data from the optical storage medium in order to determine an amount and characteristic of optical storage medium damage at 1103. At 1104, it is determined whether or not the storage medium is sufficiently reliable to be certified based on human experience data. When it is, a certification for the optical storage medium is issued at 1105. This is optionally in the form of printing a certification report along with a certification label. Alternatively, it provides a visual indication of certification and a pre-prepared label is then affixed to the medium. At 1106, a fee is charged for the certification. Thus, for example, the provider of the optical storage media generates revenue from the used media market or, alternatively, someone else receives the fee. Further alternatively, no fee is charged.

When the storage medium is not suitable for certification, the certification process fails and the optical storage medium remains uncertified.

Alternatively, once evaluated as unsuitable an optical storage medium is provided for repair and then reevaluated. By repeating the process, it is possible to move unsuitable optical storage media into a suitable category through cleaning of the medium, polishing of the medium, and so forth.

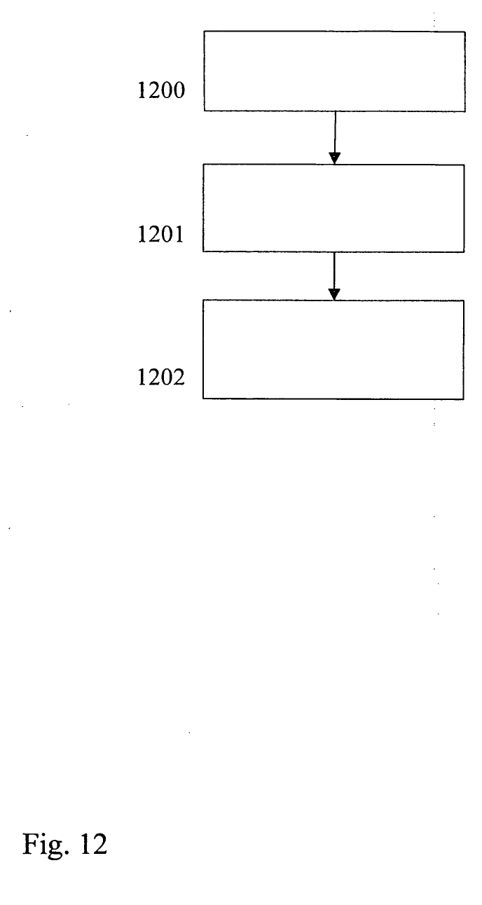

Referring to FIG. 12, shown is a simplified flow diagram of method of forming a table relating to human experience for video games. Several copies of an optical storage medium in the form of a DVD with a video game stored thereon is provided at 1200. At 1201, each copy is damaged differently. At 1202, each copy is played and human experience data is recorded. For example, some copies do not play successfully due to errors in the program code stored on the DVD medium. Other games play successfully but with differing levels of noise, video errors, and audio errors affecting the user experience. Each user evaluates their experience in playing of the game and data relating thereto is stored. The DVDs are then each analysed to determine errors therein and a table is formed relating detected errors within the DVDs to the human experience data. Optionally, the table includes a further dimension relating to game genre or more particularly relating to game identifier.

In an embodiment, a map of an optical storage medium contents is provided such that human experience relating to execution, audio playback, video playback and other criteria are separable into separate data sets. When this is the case, a priori knowledge of a content of different portions of, for example, a DVD allows for a user experience relating to that portion of the DVD to be evaluated and recorded separately.

Presently, some video games are provided on CDs, for example PlayStation games, some are provided on DVDs, for example PlayStation 2 and XBOX games, and in the future some video games will be provided on blueray optical storage media. It is evident that other digital media are also useful for supporting video games stored thereon.

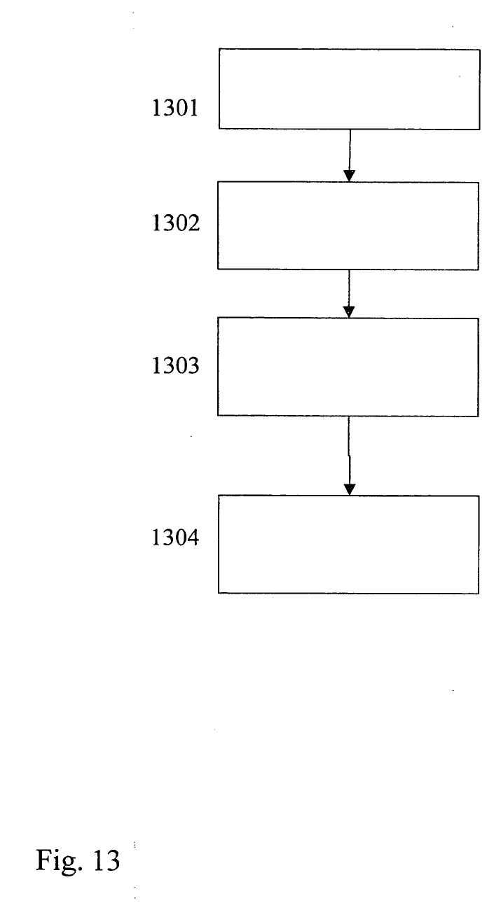

Referring to FIG. 13, shown is a method for improving error detection in optical storage media. Here, an optical storage medium is sampled at 1301 in places to identify potential errors. Individual errors are typically not of significant concern as they are often correctable. What is of concern is areas of error such as those that result from significant damage to an optical medium, dirt on an optical medium, and so forth. When errors are detected at 1302 or potentially detected, the areas with the errors therein are re-examined at 1303 at a slower rate and/or more thoroughly to determine an amount and presence of errors. In this fashion, an entire digital medium is verifiable in a shorter period of time without significant reduction in overall performance. In particular, because of a more thorough review of the optical medium in response to an indication of a potential error or potential errors, it is possible to improve the overall verification of the medium at and about blocks having errors therein. By carefully selecting the sampling frequency and pattern, it is possible to significantly reduce the overall risk that damaged media will go completely undetected when the damage is sufficiently significant to render the media unusable or highly problematic. Once the areas are re-examined, at 1304 an indication of the verification result for the optical medium is provided.

Though the above described embodiments relate to a use of a look up table for the purpose of encoding the human experience relating to known damage, it is also possible to use the human experience data to form a statistical model to map determined damage into a potential human experience measure. Here, human experience data and detected error data are correlated and a statistical model is formed for mapping known human experience data to known detected damage. As a result newly detected damage that is other than known remains mappable to a likely human experience. For this purpose, a mathematical transform is suggested. Alternatively, a neural network is employed. Further alternatively an iterative process is used to determine a suitable mapping. For example, the iterative process employs a genetic algorithm. Alternatively, it is a recursive process.

In an embodiment, the statistical process is based on a two-step thresholding of detected errors. In a first pass through the digital data, point checks are performed at intervals. In the case of an optical storage medium, point checks are performed across the disc with comparatively large intervals to the size of data checked. When this point check returns more errors than a first threshold, the system scans every data point within a previous interval, the interval, and an interval beyond an interval in which the first threshold was exceeded. When a predefined number of detected errors in the intervals as detected in the scan of every point exceeds a second threshold, the disc is indicated as bad and ejected. The first threshold and the second threshold and the interval are determined statistically based on the human experience data provided in reviewing an entertainment event based on the digital data. Of course, three or more thresholds are supported wherein each represents a different scan depth within the digital data. Further alternatively, other threshold values are used and are determined statistically or, alternatively, are stored within a look up table.

Alternatively, instead of analyzing and reviewing the entire digital data, digital data is reviewed until sufficient errors are determined to render the digital data unacceptable or unverified. Thus, once sufficient errors are detected to fall outside of, for example, the two thresholds, the process ends providing an indication of a result.

Though the above embodiments describe evaluating a user experience in, for example, watching a DVD movie by having an individual watch the movie and provide human experience data, the embodiments support evaluating a user experience on several different playback systems to determine capture information relating to damage that causes problems on some playback systems and not on other playback systems. Optionally, the data is then correlated with a customer's playback equipment. Further optionally, the data is then used to determine a likelihood that a human entertainment experience will be adversely affected in a statistical sense. Further alternatively, information relating to a worst resulting playback is used.

Numerous other embodiments may be envisaged without departing from the spirit or scope of the invention.

What is claimed is:

1. A method of grading a level of damage to digital data comprising:
providing first data based on at least one of human audio perception and human visual perception for use in mapping of detected errors within digital data onto a grade of playing quality;
detecting within the digital data first errors in retrieving of data therefrom; and,
based on the first errors and the first data, determining an indication of a grade of playing quality of the digital data, the grade of playing quality being related to at least one of human audio perception and human visual perception.

2. A method according to claim 1 wherein the first data comprises a lookup table.

3. A method according to claim 2 comprising determining the first data by
a user providing in response to perceiving entertainment based on the digital data having detected errors therein an indication of a grade of playing quality of the entertainment; and,
compiling the user provided indications into a look up table having one or more indices determinable from the detected errors.

4. A method according to claim 2 wherein the digital data is stored within an optical storage medium.

5. A method according to claim 2 comprising determining the first data by
analysing digital data having a plurality of different groups of detected errors therein to determine an indication of a human perceptible grade of playing quality of each digital data; and,
compiling the indications into a look up table having one or more indices determinable from the detected errors.

6. A method according to claim 5 wherein analyzing comprises determining a harmonicity of audio playback based on the digital data.

7. A method according to claim 1 wherein the first data comprises a statistical mapping of detected errors onto a determined indication of grade of playing quality.

8. A method according to claim 7 comprising determining the first data by
a user providing in response to perceiving entertainment based on the digital data having detected errors therein an indication of a grade of playing quality of the entertainment; and,
compiling the user provided indications into a statistical mapping of detected errors to human experience of entertainment.

9. A method according to claim 7 wherein the statistical mapping comprises a suitably weighted neural network.

10. A method according to claim 7 wherein the digital data is stored within an optical storage medium.

11. A method according to claim 1 wherein the digital data is stored within an optical storage medium.

12. A method according to claim 1 wherein the first data comprises a process for analyzing the digital data to determine an effect of detected errors within the digital data on a human perceptible event based on the digital data.

13. A method according to claim 12 wherein the process determines a harmonicity of audio playback relating to the digital data.

14. A method according to claim 1 wherein the first data comprises mapping data, the mapping data providing an indication of locations within the digital data and a likelihood that errors at each location result in human perceptible errors in playback of an event based on the digital data.

15. A method according to claim 1 wherein the indication comprises a first indication relating to audio quality and a second other indication relating to video quality.

16. A method according to claim 1 comprising:
providing a group within which the digital data falls; and,
wherein the indication is based upon the group, indications for a same detected errors different for different groups.

17. A method according to claim 1 comprising:
determining an identifier identifying the digital data; and,
wherein the indication is based upon the identifier, indications for a same detected errors different for some different identifiers.

18. A method according to claim 1 wherein the digital data is stored within an optical medium and wherein the digital data comprises at least one of music data, video data, and video game data.

19. A method according to claim 1 comprising:
when the indication is of digital data having a quality above a predetermined threshold quality, certifying the digital data.

20. A method according to claim 11 comprising:
when the indication is of digital data having a quality above a predetermined threshold quality, certifying the optical storage medium.

21. A method comprising:
inspecting an optical disk having data stored therein for detecting defects;
determining a plurality of statistical values in dependence upon the detected defects;
providing a statistical process for mapping the plurality of statistical values onto a quality of playback, the quality of playback relating to a human perceptible quality of playback;
using the statistical process, mapping the statistical values onto a quality of playback to determine a statistical quality of playback; and,
providing first inspection data if the defect index is within a predetermined range of a table index indicative of a grade of sufficient playing quality.

22. A method for inspecting an optical disk having data stored therein comprising:
scanning the optical disk for detecting defects;
determining a defect index in dependence upon the detected defects;
providing a look-up table comprising a plurality of table indices, wherein each table index of the plurality of table indices is indicative of a grade of playing quality of data stored in an optical disk in presence of a respective pattern of defects of a plurality of different patterns of defects, the grade of playing quality being determined based on at least one of human audio and human visual perception;
comparing the defect index with the table indices; and,
providing first inspection data if the defect index is within a predetermined range of a table index indicative of a grade of sufficient playing quality.

23. A method for inspecting digital data comprising:
scanning the digital data for detecting defects;
determining scan data in dependence upon the detected defects;
providing playing quality data indicative of a plurality of grades of playing quality of data stored in an optical disk, wherein each grade is determined based on at least one of human audio and human visual perception of the digital data in presence of a respective pattern of defects of a plurality of different patterns of defects;
correlating the scan data with the playing quality data and providing a result in dependence thereupon; and,
providing first inspection data when the comparison result is indicative of a grade of sufficient playing quality.

24. A method according to claim 23 wherein correlating comprises looking up the respective pattern of defects within a look up table.

25. A method according to claim 24 wherein the digital data is stored within an optical storage medium.

26. A method according to claim 23 wherein correlating comprises statistically mapping the respective pattern of defects onto a grade of playing quality.

27. A method according to claim 26 wherein the digital data is stored within an optical storage medium.

28. A method comprising:
providing digital data having data therein;
generating an entertainment event based on the digital data;
providing the entertainment event to a user;
receiving from the user quality data relating to a quality of the entertainment event;
analyzing the digital data to determine the errors therein; and,
determining a correlation between the determined errors and the user quality data.

29. A method according to claim 28 wherein the correlation comprises a look up table.

30. A method according to claim 28 wherein the correlation data comprises a statistical mapping between detected error data and quality data.

31. A method according to claim 28 wherein the correlation data comprises a plurality of weights of a neural network.

32. A method of grading a level of damage to digital data comprising:
receiving the digital data from a user, the digital data being identified by a name label;
scanning the digital data for detecting defects, the scanning performed at one of a plurality of locations, each of the plurality of locations being identified by a location label;
determining a defect index in dependence upon the detected defects;
receiving from the user of the digital data a user quality data level relating to the quality of an entertainment event from the use of the digital data by the user, the user quality data level being one of a plurality of pre-determined user quality data levels;
providing at least an entry into a database of quality perception, the at least an entry being at least one of the name label, the defect index, the location label, the date of the scanning of the digital data, and the time of scanning the digital data.

33. A method according to claim 32 further comprising:
performing a statistical analysis of the centralized database;
using the statistical analysis as part of the step of determining at least one of the defect index and the user quality data.

34. A method according to claim 32 further comprising:
transmitting the database of quality perception from the location to a central database of quality assessments.

35. A method according to claim 34 further comprising:
combining the database of quality perception from each of the plurality of locations with a centralized quality database;
performing a statistical analysis of the centralized database.

36. A method according to claim 35 further comprising:
transmitting the statistical analysis of the centralized database to each of the plurality of locations.

37. A method according to claim 36 further comprising:
using the statistical analysis as part of the step of determining at least one of the defect index and the user quality data.

38. A method according to claim 32 further comprising:
deciding based upon the user quality data level being within a first sub-set of the pre-determined user quality data levels returning the digital data to an inventory, and
wherein the user quality data level is other than within the first sub-set of the pre-determined user quality data levels determining whether the user quality data is within a second sub-set of the pre-determined user quality data levels for determining whether the digital data should be at least one of cleaned, re-written and scrapped.

39. A method according to claim 34 wherein the storage medium is an optical storage medium.

40. A storage medium having stored therein data for when executed resulting in an assessment of digital data quality comprising:
scanning digital data for detecting defects, the scanning performed at one of a plurality of locations, each of the plurality of locations being identified by a location label;
determining a defect index in dependence upon the detected defects;
receiving from the user of the digital data a user quality data level relating to the quality of an entertainment event from the use of the digital data by the user, the user quality data level being one of a plurality of pre-determined user quality data levels;
providing at least an entry into a database of quality perception, the at least an entry being at least one of the name label, the defect index, the location label, the date of the scanning of the digital data, and the time of scanning the digital data.

41. A storage medium having stored therein data for when executed resulting in an assessment of digital data quality comprising:
providing digital data having data therein;
generating an entertainment event based on the digital data;
providing the entertainment event to a user;
receiving from the user quality data relating to a quality of the entertainment event; analyzing the digital data to determine the errors therein; and,
determining a correlation between the determined errors and the user quality data.

42. A storage medium having stored therein data for when executed resulting in an assessment of digital data quality comprising:
scanning digital data for detecting defects;
determining scan data in dependence upon the detected defects;
providing playing quality data indicative of a plurality of grades of playing quality of data stored in an optical disk, wherein each grade is determined based on at least one of human audio and human visual perception of the digital data in presence of a respective pattern of defects of a plurality of different patterns of defects;
correlating the scan data with the playing quality data and providing a result in dependence thereupon; and,
providing first inspection data when the comparison result is indicative of a grade of sufficient playing quality.

43. A storage medium having stored therein data for when executed resulting in an assessment of digital data quality comprising:
inspecting an optical disk having data stored therein for detecting defects;
determining a plurality of statistical values in dependence upon the detected defects;
providing a statistical process for mapping the plurality of statistical values onto a quality of playback, the quality of playback relating to a human perceptible quality of playback;
using the statistical process, mapping the statistical values onto a quality of playback to determine a statistical quality of playback; and,
providing first inspection data if the defect index is within a predetermined range of a table index indicative of a grade of sufficient playing quality.

44. A method for inspecting an optical disk having data stored therein comprising:
scanning the optical disk for detecting defects;
determining a defect index in dependence upon the detected defects;
providing a look-up table comprising a plurality of table indices, wherein each table index of the plurality of table indices is indicative of a grade of playing quality of data stored in an optical disk in presence of a respective pattern of defects of a plurality of different patterns of defects, the grade of playing quality being determined based on at least one of human audio and human visual perception;
comparing the defect index with the table indices; and,
providing first inspection data if the defect index is within a predetermined range of a table index indicative of a grade of sufficient playing quality.

45. A method according to claim 35 wherein the statistical analysis is performed by at least one of a software application, a programmed microprocessor and a neural network.

46. A method according to claim 32 wherein the digital data is stored within at least one of a read-only storage medium and a programmably re-writable storage medium.
